(19) United States
(12) Patent Application Publication
(10) Pub. No.: US 2025/0018745 A1
(43) Pub. Date: Jan. 16, 2025

(54) TWO-WHEELER TIRE, PREFERABLY BICYCLE TIRE, AND METHOD FOR PRODUCING A TWO-WHEELER TIRE, PREFERABLY BICYCLE TIRE

(71) Applicant: Continental Reifen Deutschland GmbH, Hannover (DE)

(72) Inventors: Rainer Kahner, Arnsberg (DE); Alexander Burkhart, Essen (DE); Erin Klokkers, Stadthagen (DE); Thorsten Torbrügge, Langenhagen (DE)

(73) Assignee: Continental Reifen Deutschland GmbH, Hannover (DE)

(21) Appl. No.: 18/695,656

(22) PCT Filed: Sep. 20, 2022
(86) PCT No.: PCT/DE2022/200219

§ 371 Date: Mar. 26, 2024

(30) Foreign Application Priority Data
Sep. 30, 2021 (DE) 10 2021 211 028.2

(51) Int. Cl. B60C 1/00; C08K 3/36; C08L 9/06

(52) U.S. Cl. CPC B60C 1/00; C08K 3/36; C08L 9/06; B60C 2200/12; C08L 2205/025; C08L 2205/035; C08L 2207/24

(57) ABSTRACT

A two-wheeler tire, preferably a bicycle tire, and to a process for producing a two-wheeler tire, preferably a bicycle tire. The two-wheeler tire includes in at least one component a rubber mixture containing at least the following constituents: at least one rubber, preferably at least one diene rubber; and at least one substance from renewable raw materials which is distinct from rubber.

### CROSS-REFERENCE TO RELATED APPLICATIONS

The present application is a National Stage Application under 35 U.S.C § 371 of International Patent Application No. PCT/DE2022/200219 filed on Sep. 20, 2022, and claims priority from German Patent Application No. 10 2021 211 028.2 filed on Sep. 30, 2021, the disclosures of which are herein incorporated by reference in their entireties.

### TECHNICAL FIELD

The invention relates to a two-wheeler tire, preferably a bicycle tire, and to a process for producing a two-wheeler tire, preferably a bicycle tire.

### BACKGROUND

It is known that depending on their construction two-wheeler tires, in particular bicycle tires, comprise one or more components made of at least one rubber mixture.

It is also known that there is a general desire to employ materials that are as sustainable and environmentally friendly as possible in rubber mixtures for vehicle tires. Thus, WO 2016/105932 A1 discloses the use of vegetable oil and recycled rubber particles in the subtread of vehicle tires, though bicycle tires are not mentioned at all.

However the use of such materials affects the physical properties of the respective rubber mixture, which can result in disadvantages in rolling resistance and/or wet grip characteristics and abrasion.

It should additionally be noted that, as a result of trade-offs, improvement of the rubber mixture in respect of a physical property, for example by attempting to overcome disadvantages of individual constituents, results in worsening of another physical property. Such trade-offs exist for example between rolling resistance and grip characteristics (dry and wet grip) and between rolling resistance and abrasion characteristics.

### SUMMARY

It is an object of the present invention to provide a two-wheeler tire, preferably bicycle tire, which has a more sustainable composition without exhibiting adverse effects on its properties having regard to the requirements of vehicle operation. In particular, the two-wheeler tire shall exhibit no significant disadvantages in rolling resistance characteristics or shall even exhibit improved rolling resistance characteristics.

It is also a further object of the invention that grip characteristics, in particular wet grip characteristics, and abrasion characteristics shall not be significantly adversely affected. Especially the trade-off between rolling resistance and wet grip shall not be adversely affected.

The two-wheeler tire, preferably bicycle tire, according to the invention is characterized in that it comprises in at least one component a rubber mixture containing at least one substance from renewable raw materials.

### DETAILED DESCRIPTION

For the sake of simplicity the rubber mixture of the at least one component of the two-wheeler tire according to the invention is hereinbelow referred to for short as “rubber mixture of the two-wheeler tire according to the invention” or even as “rubber mixture”.

In the context of the present invention the term “substance from renewable raw materials” is to be understood as meaning a substance which is chemically produced from renewable raw materials as a source or is itself a raw material from renewable sources, wherein plant-based sources in particular are preferred.

However, in the context of the present invention the substance from renewable raw materials is distinct from rubber and thus especially distinct from natural rubber.

This means that irrespective of the rubber selected at least one substance from renewable raw materials which is distinct from rubber is present.

Any natural rubber present in the rubber mixture of the two-wheeler tire according to the invention is thus referred to as “rubber” in the context of the present invention.

The rubber mixture of the two-wheeler tire according to the invention thus contains at least one substance from renewable raw materials and optionally also natural rubber as a rubber.

The two-wheeler tire according to the invention has the advantage that it has a more sustainable composition and simultaneously has no disadvantages in terms of its physical properties. In particular the two-wheeler tire according to the invention shows no significant disadvantages or even shows an improvement in rolling resistance characteristics while the remaining properties, in particular grip, in particular wet grip, and abrasion characteristics remain at a comparable level.

The two-wheeler tire according to the invention thus actually shows an improvement in the trade-offs between rolling resistance characteristics and abrasion characteristics and between rolling resistance characteristics and wet grip characteristics.

This is also surprising since for two-wheeler tires, in particular bicycle tires, the trade-off between rolling resistance and wet grip is intensified compared to passenger car or truck tires: In the case of two-wheeler tires, in particular bicycle tires, the operating temperatures that are relevant for heat buildup and thus rolling resistance are much lower due to the faster heat removal. The operating temperatures are therefore closer to the temperatures relevant for grip characteristics.

The process according to the invention features a higher sustainability and provides the two-wheeler tire according to the invention which surprisingly features an improvement in the recited trade-offs between rolling resistance characteristics and abrasion characteristics and between rolling resistance characteristics and wet grip characteristics.

The two-wheeler tire according to the invention and the process according to the invention thus enable a lower CO₂ footprint coupled with improved performance.

The invention comprises all advantageous embodiments which are reflected inter alia in the claims. The invention especially also comprises embodiments which result from a combination of different features with different levels of preference for these features so that the invention also comprises a combination of a first feature described as “preferred” or described in the context of an advantageous embodiment with a further feature described for example as “particularly preferred”.

The unit “phr” (parts per hundred parts of rubber by weight) used in this document is the conventional indication of quantity for mixture recipes in the rubber industry. The dosage of the parts by weight of the individual substances is based in this document on 100 parts by weight of the total mass of all high molecular weight (weight-average of molecular weight distribution M_{w} by GPC greater than 60 000 g/mol) and thus solid rubbers present in the mixture.

Preference is given to a two-wheeler tire, wherein the substance from renewable raw materials is a plasticizer from renewable raw materials. This achieves particularly good rolling resistance characteristics of the rubber mixture and thus of the two-wheeler tire while other properties remain unchanged.

The plasticizer from renewable raw materials is particularly preferably a vegetable oil. This achieves particularly good rolling resistance characteristics of the rubber mixture and thus of the two-wheeler tire while other properties remain unchanged.

The vegetable oil may be selected from any vegetable oils known to those skilled in the art.

The vegetable oil is particularly preferably selected from the group consisting of rapeseed oil and sunflower oil, rapeseed oil being very particularly preferred. This achieves very particularly advantageous rolling resistance characteristics of the rubber mixture and thus of the two-wheeler tire while other properties remain unchanged.

The rubber mixture preferably contains a plasticizer from renewable raw materials, particularly preferably rapeseed oil, in amounts of 5 to 60 phr, particularly preferably 15 to 50 phr, very particularly preferably 15 to 30 phr.

Preference is also given to a two-wheeler tire, wherein the substance from renewable raw materials is a filler from renewable raw materials.

The filler from renewable raw materials is particularly preferably silica produced from rice husk ash. This achieves very particularly advantageous rolling resistance characteristics of the rubber mixture and thus of the two-wheeler tire coupled with improved tear properties while other properties remain unchanged.

The rubber mixture preferably contains a filler from renewable raw materials, particularly preferably silica produced from rice husk ash, in amounts of 5 to 150 phr, particularly preferably 20 to 100 phr, very particularly preferably 30 to 70 phr.

“Silica produced from rice husk ash” is also known to those skilled in the art as “rice husk ash silica” (RHAS).

This is silica obtained from the inorganic combustion residues (ash) of rice husks. The ash obtained from rice husks comprises a relatively high silica proportion of more than 80% by weight and is therefore particularly suitable for obtaining silica.

The silica produced from rice husk ash present in the rubber mixture of the two-wheeler tire according to the invention preferably has a nitrogen surface area (BET surface area) (according to DIN ISO 9277 and DIN 66132) of 35 to 400 m²/g, particularly preferably of 35 to 350 m²/g, very particularly preferably of 75 to 320 m²/g and in turn very particularly preferably of 120 to 235 m²/g and a CTAB surface area (according to ASTM D 3765) of 30 to 400 m²/g, particularly preferably of 30 to 330 m²/g, very particularly preferably of 70 to 300 m²/g and in turn very particularly preferably of 110 to 230 m²/g.

A suitable silica produced from rice husk ash having a BET surface area of 155 m²/g and a CTAB surface area of 156 to 157 m²/g is obtainable for example under the trade name “Precipitated Silica K160” from FengHai (PanJin) Rice Biotechnology Co., Ltd.

Preference is also given to a two-wheeler tire, wherein the rubber mixture contains a tree resin as the substance from renewable raw materials.

The tree resin is particularly preferably a colophony resin.

The rubber mixture preferably contains 0.5 to 20 phr, particularly preferably 1 to 10 phr, very particularly preferably 1 to 5 phr of tree resin, preferably colophony resin.

Preference is also given to a two-wheeler tire, wherein the rubber mixture contains a plasticizer from renewable raw materials, preferably vegetable oil, particularly preferably rapeseed oil, and a filler from renewable raw materials, preferably silica produced from rice husk ash.

Such a two-wheeler tire has the feature that due to the plasticizer and the filler it has a composition which comprises a relatively high mass fraction of renewable raw materials and is thus sustainable. Simultaneously the two-wheeler tire surprisingly exhibits improved rolling resistance characteristics while other properties, such as abrasion and wet grip characteristics, remain unchanged.

Preference is also given to a two-wheeler tire, wherein the rubber mixture contains a plasticizer from renewable raw materials, preferably vegetable oil, particularly preferably rapeseed oil, and a filler from renewable raw materials, preferably silica produced from rice husk ash, and a tree resin, preferably colophony resin.

Such a two-wheeler tire has the feature that due to the plasticizer and the filler and the resin it has a composition which comprises a relatively high mass fraction of renewable raw materials and is thus sustainable. Simultaneously the two-wheeler tire surprisingly exhibits improved rolling resistance characteristics while other properties, such as abrasion and wet grip characteristics, remain unchanged.

Preference is also given to a two-wheeler tire, wherein the rubber mixture additionally contains at least one recycled substance.

In the context of the present invention “a recycled substance” is to be understood as meaning a substance obtained by reprocessing of wastes, i.e. articles that have been produced and used, or of new articles, i.e. articles that have been produced but not yet used.

Preferred wastes especially include rubber-containing wastes, such as especially end-of-life tires.

“New articles” are articles which were produced from raw materials by specific alteration thereof in the context of a value chain but were not subsequently needed. This may especially include scrap.

Here too, rubber-containing articles are preferred.

Particular preference is given to the recycled substance rubber reclaim.

Rubber reclaim is obtained from sulfur-crosslinked rubber vulcanizates by cleavage of the sulfur bridges, wherein the rubber mixtures are converted from the elastic state to the plastic state by the ongoing devulcanization (devulcanized rubber mixtures).

Processes for reclaiming sulfur-crosslinked rubber vulcanizates with the aid of various substances and in different apparatuses have long been known, with known types of reclaiming including steam reclaiming, mechanical reclaiming, thermal reclaiming, reclaiming using sound waves, reclaiming using radiation and chemical reclaiming.

It is preferable to employ a rubber reclaim which has been produced from comminuted rubber wastes, such as peeled treads, by depolymerization in an extruder.

Such a rubber reclaim has an average particle size of 1 μm to 3 mm, preferably from 1 μm to 1 mm and particularly preferably from 1 μm to 100 μm and thus exhibits relatively fine particles.

The average particle size is determined using an optical microscope.

The term “rubber reclaim” in principle also comprehends the use of different reclaimed rubbers in the absence of statements or evidence to the contrary.

Suitable starting materials for the reclaimed rubber include all vulcanized rubber articles, for example and preferably the sulfur-crosslinked rubber vulcanizates from end-of-life tires, or conveyor belts or from vulcanized waste generated in the production of technical rubber articles or pneumatic vehicle tires. In this case the actual reclaiming process is often preceded by one or more comminution steps affording vulcanized rubber granulate or vulcanized rubber powder or flour.

Preference is also given to a two-wheeler tire, wherein the rubber mixture contains a plasticizer from renewable raw materials, preferably vegetable oil, particularly preferably rapeseed oil, and a filler from renewable raw materials, preferably silica produced from rice husk ash, and a tree resin, preferably colophony resin, and at least one recycled substance, preferably rubber reclaim.

Such a two-wheeler tire has the feature that due to the plasticizer and the filler and the resin and the recycled substance it has a composition which is sustainable to a relatively high mass fraction. Simultaneously the two-wheeler tire exhibits surprisingly improved rolling resistance characteristics while other properties, such as abrasion and wet grip characteristics, remain unchanged.

According to the invention the rubber mixture of the two-wheeler tire comprises at least one rubber.

The rubber mixture of the two-wheeler tire according to the invention preferably contains at least one rubber selected from diene rubbers and rubbers having a saturated polymer chain, in particular a saturated main chain.

The diene rubber is preferably selected from the group consisting of natural polyisoprene (NR), synthetic polyisoprene (IR), butadiene rubber (BR) and styrene-butadiene rubber (SBR).

The rubber having a saturated polymer chain is preferably ethylene propylene diene rubber (EPDM).

It is particularly preferable when the rubber mixture of the two-wheeler tire contains at least one diene rubber which is preferably selected from the group consisting of natural polyisoprene (NR), synthetic polyisoprene (IR), butadiene rubber (BR), styrene-butadiene rubber (SBR).

It is preferable when the rubber mixture contains at least one natural polyisoprene, preferably in amounts of 2 to 100 phr, and in one particularly advantageous embodiment of the invention 5 to 35 phr, very particularly preferably 20 to 30 phr. This achieves particularly good processability and optimized tear properties of the rubber mixture according to the invention.

It is preferable when the rubber mixture contains at least one polybutadiene (butadiene rubber), preferably in amounts of 2 to 100 phr, and in one particularly advantageous embodiment of the invention 5 to 35 phr, very particularly preferably 20 to 30 phr. This achieves particularly good abrasion and tear properties and good processability coupled with low hysteresis loss of the rubber mixture according to the invention.

In a particularly advantageous embodiment of the invention the rubber mixture contains at least one styrene-butadiene rubber (SBR), preferably in amounts of 2 to 100 phr, and in a particularly advantageous embodiment of the invention 25 to 90 phr, very particularly preferably 40 to 60 phr. This achieves good processability coupled with low hysteresis loss and good abrasion and tear properties of the rubber mixture according to the invention.

The SBR in this case is preferably an SSBR which results in optimized hysteresis properties.

It is preferable when the rubber mixture contains a polymer blend of two or more, in particular three, of the recited rubbers NR, BR and SBR, preferably SSBR, wherein the sum of all rubbers present sums to 100 phr.

The natural and/or synthetic polyisoprene of all embodiments may be either cis-1,4-polyisoprene or 3,4-polyisoprene. However, the use of cis-1,4-polyisoprenes having a cis-1,4 proportion of >90% by weight is preferred. Such a polyisoprene is firstly obtainable by stereospecific polymerization in solution with Ziegler-Natta catalysts or using finely divided lithium alkyls. Secondly, natural rubber (NR) is one such cis-1,4-polyisoprene, for which the cis-1,4 content in the natural rubber is greater than 99% by weight.

A mixture of one or more natural polyisoprenes with one or more synthetic polyisoprenes is further also conceivable.

In the context of the present invention the term “natural rubber” is to be understood as meaning naturally occurring rubber which may be obtained from Hevea rubber trees and from “non-Hevea” sources. Non-Hevea sources include for example guayule shrubs and dandelion such as for example TKS (Taraxacum kok-saghyz; Russian dandelion).

If the rubber mixture of the invention contains butadiene rubber (i.e. BR, polybutadiene), this may be any of the types known to those skilled in the art. These include what are called the high-cis and low-cis types, with polybutadiene having a cis content of not less than 90% by weight being referred to as the high-cis type and polybutadiene having a cis content of less than 90% by weight being referred to as the low-cis type. An example of a low-cis polybutadiene is Li-BR (lithium-catalyzed butadiene rubber) having a cis content of 20% to 50% by weight. A high-cis BR achieves particularly good abrasion properties and low hysteresis of the rubber mixture.

The polybutadiene(s) employed may be end group-modified with modifications and functionalizations and/or be functionalized along the polymer chains. The modification may be selected from modifications with hydroxyl groups and/or ethoxy groups and/or epoxy groups and/or siloxane groups and/or amino groups and/or aminosiloxane and/or carboxyl groups and/or phthalocyanine groups and/or silane-sulfide groups. However, other modifications known to those skilled in the art, also known as functionalizations, are also suitable. Metal atoms may be a constituent of such functionalizations.

In the case where at least one styrene-butadiene rubber (styrene-butadiene copolymer) is present in the rubber mixture this may be selected from solution-polymerized styrene-butadiene rubber (SSBR) and emulsion-polymerized styrene-butadiene rubber (ESBR), a mixture of at least one SSBR and at least one ESBR also being employable. The terms “styrene-butadiene rubber” and “styrene-butadiene copolymer” are used synonymously in the context of the present invention.

The styrene-butadiene copolymer used may be end group-modified and/or functionalized along the polymer chains with the modifications and functionalizations recited above for the polybutadiene.

The rubber mixture of the two-wheeler tire according to the invention may further contain at least one filler which is not a substance from renewable raw materials and is preferably selected from the group consisting of carbon blacks and further silicas not produced from rice husk ash.

The terms “silica” and “silicic acid” are used synonymously in the context of the present invention.

The further silica may be any of the silica types known to those skilled in the art that are suitable as filler for tire rubber mixtures. However, particular preference is given to using a finely divided, precipitated silica which has a nitrogen surface area (BET surface area) (according to DIN ISO 9277 and DIN 66132) of 35 to 400 m²/g, preferably of 35 to 350 m²/g, particularly preferably of 85 to 320 m²/g and very particularly preferably of 120 to 235 m²/g and a CTAB surface area (according to ASTM D 3765) of 30 to 400 m²/g, preferably of 30 to 330 m²/g, particularly preferably of 80 to 300 m²/g and very particularly preferably of 115 to 200 m²/g. Such silicas lead, for example in rubber mixtures for tire treads, to particularly good physical properties of the vulcanizates. Advantages in mixture processing by way of a reduction in mixing time can also result here while retaining the same product properties, leading to improved productivity. Silicas used may thus, for example, be either those of the Ultrasil® VN3 type (trade name) from Evonik or highly dispersible silicas known as HD silicas (e.g. Zeosil® 1165 MP from Solvay).

In preferred embodiments the rubber mixture contains 5 to 150 phr, particularly preferably 20 to 100 phr, of at least one further silica.

As a result, the properties of the rubber mixture may be individually adjusted and the further silica and the silica produced from rice husk ash may be added flexibly.

In preferred embodiments the rubber mixture contains up to 10 phr of further silica not produced from rice husk ash.

As a result, the properties of the rubber mixture may be individually adjusted and the further silica and the silica produced from rice husk ash may be added flexibly.

However, in preferred embodiments the rubber mixture contains no further silica, i.e. 0 phr of silica and is thus free from silica not produced from rice husks. This has the result of achieving optimal properties and dispensing with the process step of adding further silica.

It is preferable when the rubber mixture contains the silica produced from rice husk ash as filler, preferably in amounts of 5 to 150 phr, particularly preferably 20 to 100 phr, very particularly preferably 30 to 70 phr.

It is thus especially also preferable to employ silica from rice husk ash as the main filler and thus in particular to completely or at least partially replace “conventional” silica, i.e. silica not produced from rice husk ash.

It is surprisingly the case that silica from rice husk ash has an advantageous profile of properties which especially in two-wheeler tires according to the invention, in particular bicycle tires, manifests in an improvement in the trade-offs.

It is preferable when the rubber mixture contains 1 to 20 phr, particularly preferably 3 to 10 phr, of at least one carbon black.

Suitable carbon blacks include any carbon black types known to those skilled in the art.

In one embodiment the carbon black has an iodine number according to ASTM D 1510, also known as the iodine adsorption number, between 30 and 250 g/kg, preferably 30 to 180 g/kg, particularly preferably 40 to 180 g/kg, and very particularly preferably 70 to 130 g/kg, and a DBP number according to ASTM D 2414 of 30 to 200 ml/100 g, preferably 70 to 200 ml/100 g, particularly preferably 90 to 160 ml/100 g.

The DBP number according to ASTM D 2414 determines the specific absorption volume of a carbon black by means of dibutyl phthalate.

The rubber mixture may additionally contain at least one plasticizer which is distinct from a substance from renewable raw materials and is preferably selected from the group consisting of mineral oils, phosphoric esters such as tri(2-ethylhexyl)phosphate and liquid rubbers having a weight-average molecular weight distribution M_{w} according to GPC of 60 000 g/mol or less.

When using mineral oil this is preferably selected from the group consisting of DAE (distillated aromatic extracts), RAE (residual aromatic extract), TDAE (treated distillated aromatic extracts), MES (mild extracted solvents), white mineral oils and naphthenic oils, wherein RAE is particularly preferred.

In preferred embodiments the rubber mixture contains 5 to 60 phr, particularly preferably 15 to 50 phr, very particularly preferably 15 to 30 phr, of at least one mineral oil plasticizer, preferably RAE.

However, in preferred embodiments the rubber mixture contains no mineral oil plasticizer, i.e. 0 phr of mineral oil plasticizer. The rubber mixture preferably contains a plasticizer from renewable raw materials, particularly preferably rapeseed oil, in amounts of 5 to 60 phr, particularly preferably 15 to 50 phr, very particularly preferably 15 to 30 phr.

The rubber mixture may further comprise customary additives in customary parts by weight which are added preferably in at least one primary mixing stage during the production of said mixture. These additives include
a) aging stabilizers such as for example diamines, such as N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-(1,4-dimethylpentyl)-N′-phenyl-p-phenylenediamine (7PPD), N-isopropyl-N′-phenyl-p-phenylenediamine (IPPD) and/or triazines, such as 2-N,4-N,6-N-tris[4-(5-methylhexan-2-ylamino)phenyl]-1,3,5-triazine-2,4,6-triamine (PPD triazine) and/or dihydroquinolines, such as 2,2,4-trimethyl-1,2-dihydroquinoline (TMQ), and N-phenyl-1-naphthylamine (PAN), 2,2′-methylenebis(4-methyl-6-tert-butylphenol) (BKF), butylhydroxytoluene (BHT), poly(dicyclopentadiene-co-p-cresol), styrenized phenol (SAPH) and 1,3-dihydro-4-methyl-2H-benzimidazole-2-thione (MMBI),
b) activators, for example zinc oxide and fatty acids (e.g. stearic acid) and/or other activators, such as zinc complexes, for example zinc ethylhexanoate,
c) activators and/or agents for binding of fillers, in particular carbon black, for example S-(3-aminopropyl)thiosulfuric acid and/or metal salts thereof (binding to carbon black) and silane coupling agents (binding to silica),
d) antiozonant waxes,
e) resins, especially tackifying resins,
f) masticating aids, for example 2,2′-dibenzamidodiphenyl disulfide (DBD), and
g) processing aids, such as in particular fatty acid esters and metal soaps, for example zinc soaps and/or calcium soaps, and/or polyethylene glycols,
h) colorants, in particular pigments based on titanium dioxide (TiO₂), optionally in combination with color pigments.

The rubber mixture preferably contains at least one aging stabilizer selected from the group consisting of N-phenyl-N′-(1,3-dimethylbutyl)-p-phenylenediamine (6PPD) and N,N′-ditolyl-p-phenylenediamine (DTPD).

The rubber mixture of the two-wheeler tire according to the invention preferably contains at least one silane coupling agent.

The silane coupling agents may be any of the types known to those skilled in the art.

Furthermore, one or more different silane coupling agents may be used in combination with one another. The rubber mixture may thus contain a mixture of different silanes.

The silane coupling agents react with the surface silanol groups of the silica or other polar groups during the mixing of the rubber/the rubber mixture (in situ) or in the context of a pretreatment (premodification) even before addition of the filler to the rubber.

Coupling agents known from the prior art are bifunctional organosilanes having at least one alkoxy, cycloalkoxy or phenoxy group as a leaving group on the silicon atom and having as another functionality a group which, possibly after cleavage, can enter into a chemical reaction with the double bonds of the polymer. The latter group may for example comprise the following chemical groups:

—SCN,—SH,—NH₂ or —Sₓ—(withx=2 to 8).

Employable silane coupling agents thus include for example 3-mercaptopropyltriethoxysilane, 3-thiocyanatopropyltrimethoxysilane or 3,3′-bis(triethoxysilylpropyl) polysulfides having 2 to 8 sulfur atoms, for example 3,3′-bis(triethoxysilylpropyl) tetrasulfide (TESPT), the corresponding disulfide (TESPD), or else mixtures of the sulfides having 1 to 8 sulfur atoms with different contents of the various sulfides. TESPT may for example also be added as a mixture with industrial carbon black (trade name X50S® from Evonik).

Blocked mercaptosilanes as known for example from WO 99/09036 may also be used as a silane coupling agent. It is also possible to use silanes as described in WO 2008/083241 A1, WO 2008/083242 A1, WO 2008/083243 A1 and WO 2008/083244 A1. Employable silanes include for example those marketed by Momentive, USA in a number of variants under the name NXT, such as especially 3-octanoylthio-1-propyltriethoxysilane, or those marketed by Evonik Industries under the name Si 363®.

It is particularly preferable when the rubber mixture of the two-wheeler tire according to the invention contains at least one silane coupling agent selected from the group consisting of 3,3′-bis(triethoxysilylpropyl)disulfide (TESPD), 3,3′-bis(triethoxysilylpropyl)tetrasulfide (TESPT) and 3-octanoylthio-1-propyltriethoxysilane, wherein TESPD is very particularly preferred.

The proportion of the total amount of further additives is preferably 3 to 150 phr, particularly preferably 5 to 100 phr and very particularly preferably 20 to 85 phr, in turn preferably 35 to 85 phr.

Zinc oxide (ZnO) may be included in the overall proportion of the further additives. This may be any type of zinc oxide known to those skilled in the art, for example ZnO granulate or powder. The zinc oxide conventionally used generally has a BET surface area of less than 10 m²/g. However, it is also possible to use a zinc oxide having a BET surface area of 10 to 100 m²/g, for example so-called “nano zinc oxides”.

The two-wheeler tire according to the invention is preferably vulcanized. The rubber mixture is thus likewise preferably vulcanized.

The terms “vulcanized” and “crosslinked” are used synonymously in the context of the present invention.

The vulcanization of the rubber mixture is preferably performed in the presence of sulfur and/or sulfur donors with the aid of vulcanization accelerators, wherein some vulcanization accelerators may simultaneously act as sulfur donors. The accelerator is selected from the group consisting of thiazole accelerators, mercapto accelerators, sulfenamide accelerators, thiocarbamate accelerators, thiuram accelerators, thiophosphate accelerators, thiourea accelerators, xanthogenate accelerators and guanidine accelerators.

It is preferable to use a sulfenamide accelerator selected from the group consisting of N-cyclohexyl-2-benzothiazolesulfenamide (CBS),

N,N-dicyclohexylbenzothiazole-2-sulfenamide (DCBS), benzothiazyl-2-sulfenomorpholide (MBS), N-tert-butyl-2-benzothiazylsulfenamide (TBBS) and guanidine accelerators such as diphenylguanidine (DPG).

The sulfur donor substance used may be any sulfur donor substances known to those skilled in the art.

Vulcanization retarders may also be present in the rubber mixture.

The two-wheeler tire according to the invention is preferably a bicycle tire, in particular a pneumatic bicycle tire or a tubeless bicycle tire or a solid rubber bicycle tire for bicycles, preferably a pneumatic bicycle tire.

The present invention has especially made it possible to provide bicycle tires which exhibit a surprising improvement in the trade-offs between rolling resistance characteristics and abrasion characteristics and rolling resistance characteristics and wet grip characteristics.

The improvement is especially also surprising since—due to the reduced operating temperature as the reference temperature for rolling resistance—the recited trade-offs are particularly exacerbated in bicycle tires as specified above.

A two-wheeler tire according to the invention is preferably bicycle tire having a width of preferably 20 to 150 mm, particularly preferably 25 to 100 mm, very particularly preferably 25 to 70 mm, and/or an internal diameter of the tire casing of preferably 340 to 640 mm, particularly preferably 550 to 630 mm, very particularly preferably 570 to 620 mm.

The “width” is to be understood as meaning the width of the tire casing perpendicular to the direction of rotation.

Preferably and in particular the two-wheeler tire according to the invention is a bicycle tire according to the definition of the ETRTO (“European Tyre and Rim Technical Organisation”).

By way of example and preferably the bicycle tire is a racing bike tire, a city trekking, gravel or cargo bike tire, a mountain bike tire or a solid rubber bicycle tire.

In an advantageous embodiment of the invention the two-wheeler tire is a pneumatic two-wheeler tire, preferably a pneumatic bicycle tire, particularly preferably a racing bike tire, a city trekking, gravel or cargo bike tire or a mountain bike tire having a tread, a tire carcass, tire sidewalls, and in each axial half of the tire a bead region having a tire bead with a core, wherein in the bead regions the two-wheeler pneumatic tire has a protective layer which is arranged axially outside the carcass and has strength members embedded in rubber material, wherein the tire carcass is formed from a first carcass ply and a second carcass ply, each having strength members, wherein the second carcass ply is disposed in a vertex of the two-wheeler pneumatic tire radially inside the first carcass ply and extends from the vertex of the two-wheeler pneumatic tire over the tire sidewalls to both bead regions and in the latter wraps the respective core from axially inside to axially outside and terminates in a second carcass ply end radially inside a tread end of the tread and wherein the first carcass ply extends from the vertex of the two-wheeler pneumatic tire over the tire sidewalls to both bead regions and in the latter wraps the respective core from axially inside to axially outside.

Preference is also given to a two-wheeler tire, wherein the component is at least the tread and/or the cap and/or the base of a tread having cap-base construction and/or a puncture protection layer and/or a damper layer and/or at least one sidewall and/or at least one carcass ply.

It is particularly preferable when the component comprising the rubber mixture containing at least one substance from renewable raw materials which is distinct from natural rubber is the tread, in turn preferably the tread of a pneumatic bicycle tire.

The process according to the invention for producing a two-wheeler tire, preferably bicycle tire, comprises at least the steps of:
(A) producing at least one rubber mixture, wherein at least one rubber and at least one substance from renewable raw materials which is distinct from rubber is added to the rubber mixture; and
B) molding the rubber mixture from step A) into a component of a two-wheeler tire;
C) introducing the component from step B) onto or into a green tire;
D) vulcanizing the green tire from step C).

All of the above embodiments relating to the two-wheeler tire according to the invention apply to the rubber mixture and its constituents.

Steps A) to D) are otherwise carried out in a manner known to those skilled in the art using apparatuses known to those skilled in the art.

Production of the rubber mixture is otherwise carried out by the processes customary in the rubber industry comprising initially producing in one or more mixing stages a primary mixture comprising all constituents except the vulcanization system (for example sulfur and vulcanization-influencing substances). The finished mixture is produced by adding the vulcanization system in a final mixing stage.

The final mixture is subjected to further processing for example by extrusion or calendering and is brought into the appropriate shape, preferably into the shape of a tread.

The invention shall now be more particularly elucidated with reference to working examples.

Results of laboratory tests on the rubber mixture of the two-wheeler tire according to the invention and results of tire tests are summarized in tables 1 and 2. The examples marked “E” are inventive examples while those marked “V” are comparative examples.

The mixtures on which the tire tests in table 2 are based are comparable with those of the laboratory tests from table 1 and therefore, for better elucidation of the invention, table 2 reproduces only the significant constituents. The mixtures containing reclaim likewise comprise an elevated amount of sulfur and accelerators. In the tire tests the mixtures were in each case incorporated as treads. The tires were city trekking tires and had a tread width of 42 mm and an inner diameter of 622 mm.

The mixtures were otherwise produced by the process customary in the rubber industry under standard conditions in two stages in a laboratory mixer with a volume of 300 milliliters to 3 liters, in which, in the first mixing stage (basic mixing stage), all constituents apart from the vulcanization system (sulfur and vulcanization-influencing substances) were first mixed at 140 to 165° C., with target temperatures of 140 to 157° C., for 200 to 600 seconds. Addition of the vulcanization system in the second stage (final mixing stage) resulted in the production of the final mixture, with mixing at 90 to 120° C. for 180 to 300 seconds.

All of the mixtures were used to produce test specimens by vulcanization after t95 to t100 (measured on a moving die rheometer according to ASTM D 5289-12/ISO 6502) under pressure at 160° C. and these test specimens were used to determine material properties typical for the rubber industry by the test methods specified hereinbelow.
Loss factor tan d, synonymous with tan δ, at 0° C. and at 20° C. from dynamic mechanical analysis according to DIN 53 513, temperature sweep, constant deformation (10/0.2%)
Loss factor tan δ (tan d) at 0° C. and at 20° C. from dynamic mechanical analysis according to DIN 53513, temperature sweep, 50/30 N: static starting force 30 N, dynamic oscillation between 30 and 50 N
Rebound resilience at room temperature (RT) according to DIN 53 512 and ISO 4662
Stress value at 300% elongation at room temperature (M 300 RT), tensile strength and breaking elongation according to DIN 53 504
Abrasion at room temperature according to DIN/ISO 4649

### Tire Tests:

Abrasion Subjective evaluation after 1500 km of driving
Rolling friction wet test: Measuring instrument from Tyre Laboratory Wheel Energy Oy;
   Test speed/slip speed=2 mm/s; load 50 kg, tire internal pressure 4 bar

### Substances Used

a) rubber reclaim produced by reclaiming peeled end-of-life treads in a continuous process in an extruder,
b) silica: ZEOSIL® 1165 MP, BET surface area=155 m²/g (measured with nitrogen), CTAB surface area=156-157 m²/g; Solvay S. A.
c) silica from rice husk ash: silica produced from rice husks; BET surface area=155 m²/g (measured with nitrogen),
   CTAB surface area=156-157 m²/g, precipitated silica K160, FengHai (Panjin) Rice Biotechnology Co., Ltd.
d) Rapeseed oil: Rapeseed Oil STANDARD, Biona Jerzin s.r.o.
e) Indene-coumarone resin: Novares C 30, Rain Carbon Germany GmbH
f) Colophony resin: Tyreon-160, Orgkhim
g) Activators: in each case 3 phr of zinc oxide and 2 phr of stearic acid
h) Silane: TESPD

TABLE 1

| | Unit | V1 | E1 | E2 | V2 | E3 | E4 | E5 |
|---|---|---|---|---|---|---|---|---|
| Constituents | | | | | | | | |
| NR | phr | 25 | 25 | 25 | 25 | 25 | 25 | 25 |
| BR | phr | 25 | 25 | 25 | 25 | 25 | 25 | 25 |
| SSBR | phr | 50 | 50 | 50 | 50 | 50 | 50 | 50 |
| Reclaim ^{a)} | phr | — | — | — | 15 | 15 | 15 | 15 |
| N339 carbon | phr | 5.5 | 5.5 | 5.5 | 5.5 | 5.5 | 5.5 | 5.5 |
| black | | | | | | | | |
| Silica ^{b)} | phr | 55 | 55 | — | 55 | 55 | 55 | — |
| Silica from rice | phr | — | — | 55 | — | — | — | 55 |
| husk ash ^{c)} | | | | | | | | |
| RAE | phr | 22 | — | 22 | 22 | — | — | — |
| Rapeseed oil ^{d)} | phr | — | 22 | — | — | 22 | 22 | 22 |
| IC resin ^{e)} | phr | 2 | 2 | 2 | 2 | 2 | — | — |
| Tree resin ^{f)} | phr | — | — | — | — | — | 2 | 2 |
| 6PPD | phr | 2 | 2 | 2 | 2 | 2 | 2 | 2 |
| Activators ^{g)} | phr | 5 | 5 | 5 | 5 | 5 | 5 | 5 |
| Silane ^{h)} | phr | 4 | 4 | 4 | 4 | 4 | 4 | 4 |
| DPG | phr | 1 | 1 | 1 | 1 | 1 | 1 | 1 |
| TBBS | phr | 1 | 1 | 1 | 1.15 | 1.15 | 1.15 | 1.15 |
| Sulfur | phr | 1.65 | 1.65 | 1.65 | 1.81 | 1.81 | 1.81 | 1.81 |

Physical
properties

| | | | | | | | | |
|---|---|---|---|---|---|---|---|---|
| Rebound | % | 39.1 | 43.2 | 41.3 | 39.1 | 41.6 | 40.3 | 40.5 |
| resilience RT | | | | | | | | |
| M 300 | MPa | 5.7 | 4.3 | 6.2 | 5.6 | 4.6 | 4.6 | 3.9 |
| Tensile strength | MPa | 16.2 | 14.1 | 17.4 | 14.1 | 12.3 | 12 | 12 |
| Breaking | % | 677 | 751 | 655 | 630 | 653 | 660 | 719 |
| elongation | | | | | | | | |
| tan d (20° C.) | | 0.187 | 0.169 | 0.176 | 0.195 | 0.179 | 0.178 | 0.18 |
| tan d (20° C.) 50/30 | | 0.243 | 0.231 | 0.216 | 0.258 | 0.239 | 0.239 | 0.239 |
| N | | | | | | | | |

TABLE 2

| Constituents | Unit | V3 | E6 | E7 |
|---|---|---|---|---|
| Reclaim ^{a)} | phr | — | 15 | 15 |
| Silica ^{b)} | phr | 55 | — | — |
| Silica from rice husk | phr | — | 55 | 55 |
| ash ^{c)} | | | | |
| RAE | phr | 22 | — | 22 |
| Rapeseed oil ^{d)} | phr | — | 22 | — |
| IC resin ^{e)} | phr | 2 | — | — |
| Tree resin ^{f)} | phr | — | 2 | 2 |
| Properties | | | | |
| Abrasion | % | 100 | 100 | 100 |
| Rolling friction wet | | 0.62 ± 0.02 | 0.62 ± 0.02 | 0.60 ± 0.02 |
| grip | | | | |

As is apparent from the data in tables 1 and 2 the inventive examples feature improved rolling resistance indicators while abrasion and wet grip remain at a comparable level, the latter being apparent especially from the tire tests in table 2.

The results are particularly surprising since the inventive variants comprising rubber reclaim also show the corresponding rolling resistance advantages coupled with equal abrasion and wet grip. It would have been expected that especially the variants containing rubber reclaim would exhibit poorer rolling resistance characteristics and poorer abrasion characteristics.

Inventive two-wheeler tires, in particular bicycle tires, thus surprisingly show an improvement in the trade-offs between rolling resistance characteristics and abrasion characteristics and between rolling resistance characteristics and wet grip characteristics.

TABLE 3

| Constituents | Unit | V1 | E2 | E8 | E9 |
|---|---|---|---|---|---|
| NR | phr | 25 | 25 | 25 | 25 |
| BR | phr | 25 | 25 | 25 | 25 |
| SSBR | phr | 50 | 50 | 50 | 50 |
| Reclaim ^{a)} | phr | — | — | — | — |
| N339 carbon black | phr | 5.5 | 5.5 | 5.5 | 5.5 |
| Silica ^{b)} | phr | 55 | — | — | — |
| Silica from rice husk ash ^{c)} | phr | — | 55 | 55 | 55 |
| RAE | phr | 22 | 22 | — | — |
| Rapeseed oil ^{d)} | phr | — | — | 22 | 22 |
| IC resin ^{e)} | phr | 2 | 2 | — | 2 |
| Tree resin ^{f)} | phr | — | — | 2 | — |
| 6PPD | phr | 2 | 2 | 2 | 2 |
| Activators ^{g)} | ohr | 5 | 5 | 5 | 5 |
| Silane ^{h)} | phr | 4 | 4 | 4 | 4 |
| DPG | phr | 1.3 | 1.3 | 1.3 | 1.3 |
| TBBS | phr | 1 | 1 | 1 | 1 |
| Sulfur | phr | 1.65 | 1.65 | 1.65 | 1.65 |
| Physical properties | | | | | |
| Tensile strength | MPa | 12.8 | 10.6 | 13.9 | 15.1 |
| Breaking elongation | % | 695 | 620 | 822 | 902 |
| M 300 | MPa | 3.7 | 3.9 | 3.6 | 3.2 |
| Rebound resilience RT | % | 39.3 | 41.7 | 45.4 | 46.3 |
| Abrasion according | mm³ | 55 | 50 | 57 | 55 |
| to DIN ISO at 5N. | | | | | |
| Tire properties | | | | | |
| Rolling resistance | W | 21.6 | 20.0 | 19.0 | 18.7 |
| Rolling friction wet grip | | 0.64 | 0.63 | 0.59 | 0.57 |

Rolling resistance measurement according to table 3:

The results were determined in accordance with the torque method of the standard ISO 28580 at 22° C. A drum diameter of 800 mm, a load of 50 kg and a speed of 30 km/h were used.

The abrasion according to table 3 is abrasion according to DIN ISO 4649 with the modification “half load” (5 N instead of 10 N contact force).

Table 3 compares mixture examples without reclaim. The data from the tire tests show inter alia improved properties with regard to rolling resistance. These results for a two-wheeler tire, in particular bicycle tire, according to the invention surprisingly make it possible to achieve an improvement in the trade-offs between rolling resistance characteristics and abrasion resistance characteristics and between rolling resistance characteristics and wet grip characteristics.

1. A two-wheeler tire, preferably bicycle tire, the two-wheeler tire comprises in at least one component a rubber mixture containing at least the following constituents:
at least one rubber, preferably at least one diene rubber; and
at least one substance from renewable raw materials which is distinct from rubber.

2. The two-wheeler tire as claimed in claim 1, wherein the rubber mixture contains a plasticizer from renewable raw materials, particularly preferably rapeseed oil, in amounts of 5 to 60 phr, particularly preferably 15 to 50 phr, very particularly preferably 15 to 30 phr.

3. The two-wheeler tire as claimed in claim 1, wherein the rubber mixture contains a filler from renewable raw materials, particularly preferably silica produced from rice husk ash, in amounts of 5 to 150 phr, particularly preferably 20 to 100 phr, very particularly preferably 30 to 70 phr.

4. The two-wheeler tire as claimed in claim 1, wherein the rubber mixture contains a tree resin, preferably colophony resin, as the substance from renewable raw materials.

5. The two-wheeler tire as claimed in claim 1, wherein the rubber mixture contains a plasticizer from renewable raw materials, preferably vegetable oil, particularly preferably rapeseed oil, and a filler from renewable raw materials, preferably silica produced from rice husk ash.

6. The two-wheeler tire as claimed in claim 1, wherein the rubber mixture contains a plasticizer from renewable raw materials, preferably vegetable oil, particularly preferably rapeseed oil, and a filler from renewable raw materials, preferably silica produced from rice husk ash, and a tree resin, preferably colophony resin.

7. The two-wheeler tire as claimed in claim 1, wherein the rubber mixture additionally contains at least one recycled substance, preferably rubber reclaim.

8. The two-wheeler tire as claimed in claim 1, wherein it is a bicycle tire, in particular a pneumatic bicycle tire or a tubeless bicycle tire or a solid rubber tire for bicycles, preferably a pneumatic bicycle tire.

9. The two-wheeler tire as claimed in claim 1, wherein it is a bicycle tire having a width of 20 to 150 mm, particularly preferably 25 to 100 mm, very particularly preferably 25 to 70 mm, and/or an internal diameter of the tire casing of preferably 340 to 640 mm, particularly preferably 550 to 630 mm, very particularly preferably 570 to 620 mm.

10. The two-wheeler tire as claimed in claim 1, wherein the component is at least the tread and/or the cap and/or the base of a tread having cap-base construction and/or a puncture protection layer and/or a damper layer and/or at least one sidewall and/or at least one carcass ply.

11. A process for producing a two-wheeler tire, preferably a bicycle tire, wherein the process comprises at least the process steps of:
(A) producing at least one rubber mixture, wherein at least one rubber and at least one substance from renewable raw materials which is distinct from rubber is added to the rubber mixture; and
B) molding the rubber mixture from step A) into a component of a two-wheeler tire;
C) introducing the component from step B) onto or into a green tire;
D) vulcanizing the green tire from step C).

12. The two-wheeler tire as claimed in claim 1, wherein the rubber mixture contains:
a plasticizer from rapeseed oil, in amounts of 15 to 30 phr;
a filler from silica produced from rice husk ash, in amounts of 30 to 70 phr;
a colophony resin; and
rubber reclaim.
